(19) United States
(12) Patent Application Publication
(10) Pub. No.: US 2006/0007328 A1
(43) Pub. Date: Jan. 12, 2006

(54) Method of utilizing media cue cards for instruction in amateur photography and videography

(76) Inventors: Chett B. Paulsen, Sandy, UT (US); Edward B. Paulsen, Draper, UT (US); Richard B. Paulsen, Pleasant Grove, UT (US)

Correspondence Address: Parsons Behle & Latimer;Suite 1800, 201 South Main Street, P. O. Box 45898, Salt Lake City, UT, 84111, US

(21) Appl. No.: 11/176,689

(22) Filed: Jul. 7, 2005

Related U.S. Application Data
(63) Continuation-in-part of application No. 11/051,616, filed on Feb. 4, 2005.
(60) Provisional application No. 60/585,987, filed on Jul. 7, 2004.

(51) Int. Cl. H04N 5/262

(52) U.S. Cl. 348/239

(57) ABSTRACT

Disclosed herein are systems and methods useful to create multimedia presentations utilizing templates that contain scene divisions and cues to the capturing of multimedia objects applicable to a template for use in a created production. Detailed information on various example embodiments of the inventions are provided in the Detailed Description below, and the inventions are defined by the appended claims.

### CROSS REFERENCE TO RELATED APPLICATIONS

This application is a continuation-in-part of U.S. application Ser. No. 11/051,616 filed Feb. 4, 2005, which is hereby incorporated by reference in its entirety. This application further claims the benefit of the U.S. Provisional Application No. 60/585,987 filed Jul. 7, 2004, which is hereby incorporated by reference in its entirety.

### BACKGROUND

Recently consumer equipment capable of capturing images and video has become inexpensive enough for the ordinary consumer to afford. Digital cameras capture digital images that can be transported to a computer for viewing, and printing for inclusion in photo albums and scrapbooks. As these digital images require very little physical space, consumers will often have a collection of hundreds or even thousands of unorganized and unannotated images taken over several years. These collections of pictures are often not enjoyed, due to the difficulty of determining or remembering the time, place and context behind the pictures.

Products have also become available for building presentations, for example picture CDs and DVDs, from collections of images. These products have applied a single thematic mode (look and feel) to those presentations, which has resulted in flat and, to some degree, uninteresting presentations of consumer's images. Other products permit customization of a look and feel, but require specification of the modes of the presentation only possible with much learning and expertise on the part of the user. These products provide a great deal of flexibility where the average consumer would be better served with structure. It has been seen that the average consumer has been difficult to educate in even rudimentary techniques of capturing, as evidenced by the simplistic instructions in camera manuals and the popularity of automatic mechanisms including focus, shutter speed, flash and the like. Many camera manuals include instructions for taking a picture or a video, but offer little or no guidance to the consumer to create attractive presentations from his effort.

A survey of available multimedia production solutions today shows most are difficult for the average consumer to learn, are time consuming to both learn and use, require significant computational resources and provide little help to approach a professional grade presentation. None provide any instruction or guidance as to the aesthetics, narrative structure or cinematic linquigists.

### SUMMARY

Disclosed herein are systems and methods useful to create multimedia presentations utilizing templates that contain scene divisions and cues to the capturing of multimedia objects applicable to a template for use in a created production. Detailed information on various example embodiments of the inventions are provided in the Detailed Description below, and the inventions are defined by the appended claims.

### DESCRIPTION OF THE DRAWINGS

FIG. 1 depicts a conceptual method of assisting an amateur producer through the use of presentation templates.

FIG. 2 depicts a portable media device including media cue cards.

FIG. 3 depicts a more sophisticated method of assisting an amateur producer using production templates and scenes.

FIG. 4 shows a time-oriented presentation template organization.

FIG. 5 depicts an exemplary production template at a high level.

FIGS. 6A and 6B in composite shows an exemplary Movie Magic cue card including instructions for composing a presentation.

FIG. 7 shows an exemplary menu screen for a DVD-encoded production.

FIG. 8 depicts a cue card of the opening scene of an exemplary presentation.

FIGS. 9A, 9B, 9C, 9D, 9E, 9F, 9G and 9H show cue cards for successive scenes in the presentation of FIG. 8.

FIG. 10 depicts a summary of the soccer team presentation of FIGS. 11A and 11B.

FIGS. 11A and 11B show in composite an exemplary cue card for a soccer team presentation.

FIG. 12 depicts an exemplary cue card for a child's birthday party presentation in a vertical format.

FIG. 13 depicts an exemplary cue card assembly for a birthday party presentation.

FIGS. 14A and 14B in composite show a user interface for inserting multimedia objects into slots of the scene depicted in FIG. 8.

FIGS. 15A and 15B in composite show the user interface shown in FIGS. 14A and 14B with a scene as depicted in FIG. 9A selected.

Reference will now be made in detail to several examples of multimedia production systems, production templates and multimedia cue cards which may include various aspects, examples of which are illustrated in the accompanying drawings.

### DETAILED DESCRIPTION

Although the description below speaks of images, for example taken using a digital camera, it is to be understood that pictures in other formats may be equivalently used, for example photo prints through the use of a scanning step. Likewise, video clips may originate in a digital camera, an analog video source, film or any other moving-picture format when converted to a suitable format.

To facilitate the understanding of concepts related to the disclosure below, several phrases are now introduced. The definitions or meanings noted here are merely exemplary or conceptual in nature, and are not given to limit the discussion below. Rather, the reader may apply meanings to any of the terms introduced which agree with the discussion or provide objects that serve similar functions or purposes, as understood by one of ordinary skill in the art. Additionally, the introduced terms may be used in a number of contexts, and may take on meanings other than those listed below.

Audio: music or spoken audio either in the form of tapes, or digitally captured files that can be incorporated into a multimedia production, including industry standard extensions including aif, .mp3, etc.

CD-ROM: Compact Disc Read-Only Memory. An optical disc that contains computer data.

DVD: Digital Versitile Disc or Digital Video Disc. An optical storage medium which can be used for multimedia and data storage.

Element: single, basic, multimedia item(s); such as a photograph, image, video clip, audio clip, document, and textual caption, with defined programmed behavior and characteristics. A number of examples are discussed below.

Attributes: include the type, size, physical descriptions, behavior and characteristic of the individual element.

Behavior: describes the way elements, scenes and presentation templates behave, some examples of which are movement, transition in, transition out, timing, duration, rotation, beginning and ending position.

Characteristics: describes the file type, size, resolution and added attributes, some examples of which are frames, drop shadows, opacity, and color of the element, scene, presentation, production or navigation.

Element Object Model: specification of how elements in a production are represented, it defines the attributes associated with each element and how elements and attributes can be manipulated.

Images: a picture. Images on a computer are usually represented as bitmaps (raster graphics) or vector graphics and include file extension like jpg, .bmp, tif

Kiosk: multi-media enabled computer, monitor, keyboard and application housed in a sturdy structure in a public place.

Multimedia: communication that uses any combination of different media. Multimedia may include photographs, images, video and audio clips, documents and text files.

Populating Multimedia: a method or process where multimedia elements (photos, images, audio clips, video clips, documents, text files) are automatically introduced into Element Object Models that have been organized as presentation templates. Source media may be introduced by any data transfer method including memory sticks, wireless or wired networks, directories on a computer, or other hardware. Organization of digital media files can be by name, date, theme, or other advanced media analysis technique.

Portable media device: a portable device that includes a memory and an interface for accessing the memory electronically. Examples are CompactFlash cards, SD cards and Memory Sticks.

Presentation Template (Storyboard): a number of predefined scenes organized together with scene transitions using artistic, cinematic or narrative structure.

Production: a production template that has been populated with user contributed elements and context. Completed productions can be saved, rendered or burned to CD-Rom or DVD.

Production Template (Layout): a collection of presentation types which may contain an introduction, main body, navigator, and credits.

Render: faithfully translate into application-specific form allowing native application operations to be performed. The method of converting polygonal or data specifications of an image to the image itself, including color and opacity information.

Scene: includes individual elements choreographed to interact on different levels over time, each exhibiting behaviors and characteristics within the confines of the scene structure.

Template: describes the ‘state’ of a production prior to User contributed elements.

Video: a series of framed images put together, one after another to simulate motion and interactivity, motion pictures, home video, that can be digitally reproduced, including industry digital signature of avi, .m2v, .mp4, etc.

Multimedia presentation template systems

Recently manufacturers have begun to produce multimedia recording equipment, such as digital still and video cameras, at a price affordable to the ordinary consumer. Although some of this equipment has been provided with some modest editing capabilities, there has been a general lack of structured help to the consumer to organize his pictures and/or video clips into a production. Indeed, many consumers maintain a shoe-box, or an electronic equivalent, wherein is deposited years of pictures and/or video awaiting an opportunity to be organized into a scrapbook or other presentation. Furthermore, an average consumer posesses only moderate skill to take stand-alone stills and video clips, and most lack any skill to capture visual or audio material suitable for a coherent amateur production.

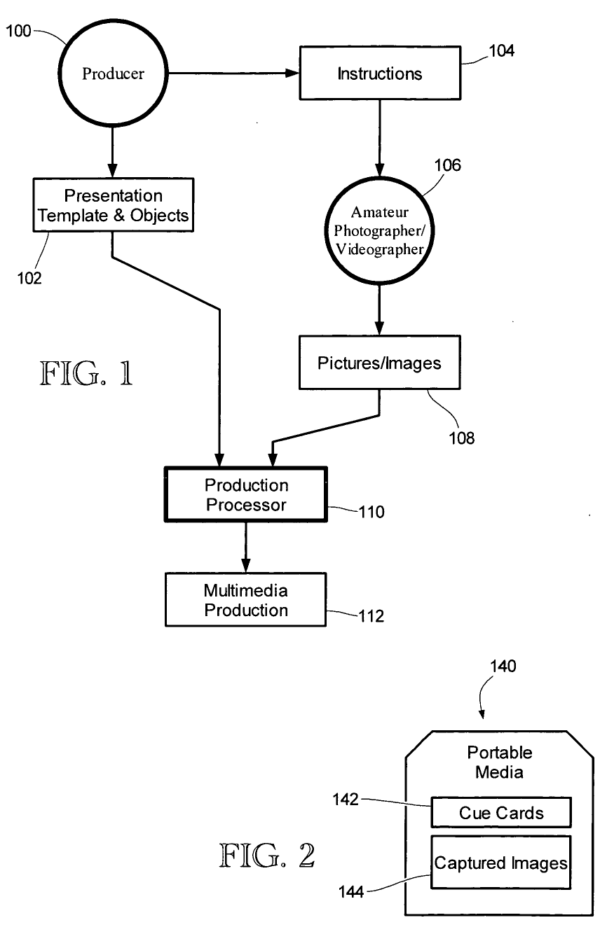

One method of helping an amateur producer uses presentation templates. Depicted in FIG. 1 at a conceptual level is such a method. The process begins with a producer 100, who produces a presentation template and objects 102. The template contains descriptions, readable by a processor 110, that describe the structure of a presentation including references to background images, frames, effects, transitions, audio and other presentational elements. Where images or audio are referenced, these and other objects may accompany the presentation template to make them available at the time of production. A presentation template may advantageously be made generic so as to be useful across a wide audience.

Producer 100 may wish to provide instructions 104 concerning the multimedia material to be applied to the presentation template. Instructions 104 might instruct or suggest an overall theme to the presentation, and give general advice to how to take appropriate, properly composed, or good-quality pictures and/or video. For example, if the template is for a sporting event, the instructions might suggest placing a player three feet in front of the net and framing the player in the left one-third of the frame and zooming in to get a “head and shoulders” shot in addition to the use of a fast shutter speed or “sports” setting on the camera. Utilizing instructions 104, the amateur 106 takes a number of pictures and/or images 108. The amateur 106 then transports objects 108 to a production processor 110. Utilizing the presentation template, processor 110 integrates objects 108 to produce a multimedia production 112, optionally by using a production template specifying elements related to the final media form and format. Theoretically, using this method a number of amateur photographers may produce relatively high-quality presentations without posessing skills beyond the basics of operating a camera or other capturing equipment, as the skill to produce at that high-quality is applied and recorded in the presentation template.

It is possible to refine that method to provide more structure and help to the amateur producer. One undiscovered method utilizes scenes and templates providing not only more interesting and appealing productions through the use of template provided special effects, scene structure, and stock art, but also an easing of the skill level required to accommodate the amateur producer. Scenes are subdivisions of a production, and define common properties for slots grouped under a scene for the insertion of multimedia objects. In a linear production, such as a passive video presentation, scenes might be as short as a few seconds or as long as several minutes depending on the theme, quality and type of multimedia objects that are to be displayed in the scene.

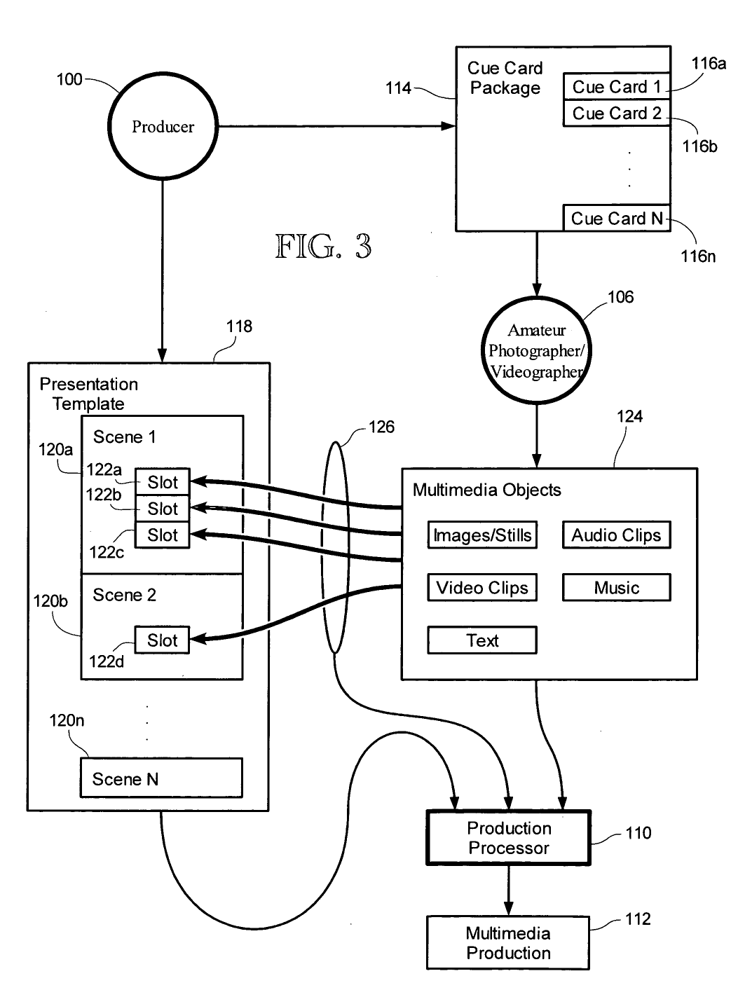

Referring now to FIG. 3, a producer creates a presentation template 118 containing automated software executables for creating a multimedia production 112. As will be discussed below, presentation 118 may be directed to a life event, holiday or other occurrence. Included in presentation template 118 are scene templates 120a to 120n. Within the scene templates are defined slots 122a to 122d wherein multimedia objects may be selected for insertion by the user in the presentation. For each scene template, template elements, which will be described presently, are specified. The specified template elements may differ between scenes, providing interesting changes within the production 112 to the audience, and diminish the monotony and ‘flatness’ that can be experienced in a presentation without scenic change.

Producer 100, with the presentation template 118, prepares a cue card package 114, which in this example includes one cue card 116a-n per each of scene templates 120a-n. Media cue cards (or simply ‘cue cards’) 116 are provided in a format accessible to amateur 106, and cue card package 114 may provide containment or organization of those cue cards. Cue card package 114 and cue cards 116 can be fashioned in many forms, some of which will be described below. Cue cards 116 provide instructions corresponding to particular scenes 120 in the presentation template, suggesting techniques, settings, composition, views and other instructions directing amateur 106 to capture or insert material approprate for the scenes in the presentation. Cue cards may contain any of the following: 1) an outline of items and materials needed to capture the multimedia objects contained on the particular media cue card needed for a specific story, 2) an order and content of images arranged to tell a story with a start, middle and end, 3) the subject matter of images to be applied, 4) characteristics of each image such as image context, lighting and motion, 5) a distance or vantage from image subject such as establishing shot, head shot, full body shot, group shot, landscape, object, lighting, etc., 5) a visual and written description of each element and image, and 6) additional elements needed to provide additional context and the “finishing touch” for the specific story such as the use of text, fonts, audio and music appropriate for the story.

Acting on instructions of cue cards 116, or following his own initiative, amateur 106 captures material in the form of multimedia objects 124, examples of which are images, video clips, audio clips, music and text. Having captured those objects, the amateur may then specify which objects to insert in each slot. If objects 124 are located on a storage medium (or several media) the slot-to-object specifications may be file references readable by the production processor. Having access to the presentation template 118, slot specifications 126 and objects 124, production processor may create a multimedia production 112.

For a template or a division thereof, template elements may be prescribed by the producer. These elements define audio and visual objects or effects that are applied to the scenes or presentation, and may additionally be applied to multimedia objects inserted to the slots. These effects can take a wide variety of forms, and may be applied by the production processor at the time of production creation.

Template elements may take the form of static visual elements. A background element, for example, may specify an image appearing behind other visual objects. Frames may likewise be prescribed, and even more complex effects may be specified through the use of masks, pixel shaders, or transparency layers with images. Simpler graphical forms may also be specified as elements, for example lines and fields of color or pattern.

Elements may also specify visual objects in motion. A motion path may be specified for an object, as well as properties of the object with respect to the path. For example, an object might be specified to move from left to right while zooming down. Another object might be specified to circle the screen while flipping.

Visual elements and slots may also have specified a location, in terms of Cartesian coordinates, justification or other positional directives. A level of ‘Z’ or depth may also be prescribed for any visual object. Objects may also be positioned with relative justifications, for example left, center, right, full, top bottom, upper-right, etc. Elements and slots may also specify rotations and other positional factors.

Visual elements and slots may also have applied computational effects. Examples of these are mattes, edges, shadows, ghost images, special lighting, embossment, distortions and many others.

Other visual elements may be specified as text, or as a slot for text, and may include definitions for textual properties such as font type, size and color. Other textual properties may be specified such as justification, spacing, the size and position of an enclosing text box, or any other property or effect that might be applied to text.

Video elements may also be specified, for example identifying a video clip. Effects to the video clip may also be specified by element, for example speed up, slow down, zoom, resize, sepia, etc. Audio elements may also be prescribed. These may include the playing of a sound file, or the application of an audio transformation to audio inserted to a slot. It may also include multiple audio sources and their volume in relation to other audio.

Transitions may also be specified as elements. Those transitions may include scene to scene transitions, image transitions, audio transitions, and others. Visual transitions may include fade in/out, spin, blur in/out, enter from the left or right, sizing, zooming, rolling, rotating, wiping, color saturation manipulation or other transition as desired. An element may have multiple transitions, for example and entrance and exit transition. Audio transitions may include fade in/out, cross-mixing, speed or pitch changes, or other effects as desired.

A longevity value, or other temporal factor, may also be specified for any element. For example, if a scene includes several images each image may be prescribed to appear or disappear at particular times in a presentation. Likewise for any visual or audio element a start and end time, or alternatively a start and length time or other periodic delimitation, may be specified.

Production level elements may also be specified, for example a DVD menu construction or playback format (such as NTSC) including chapters, flags, and the like.

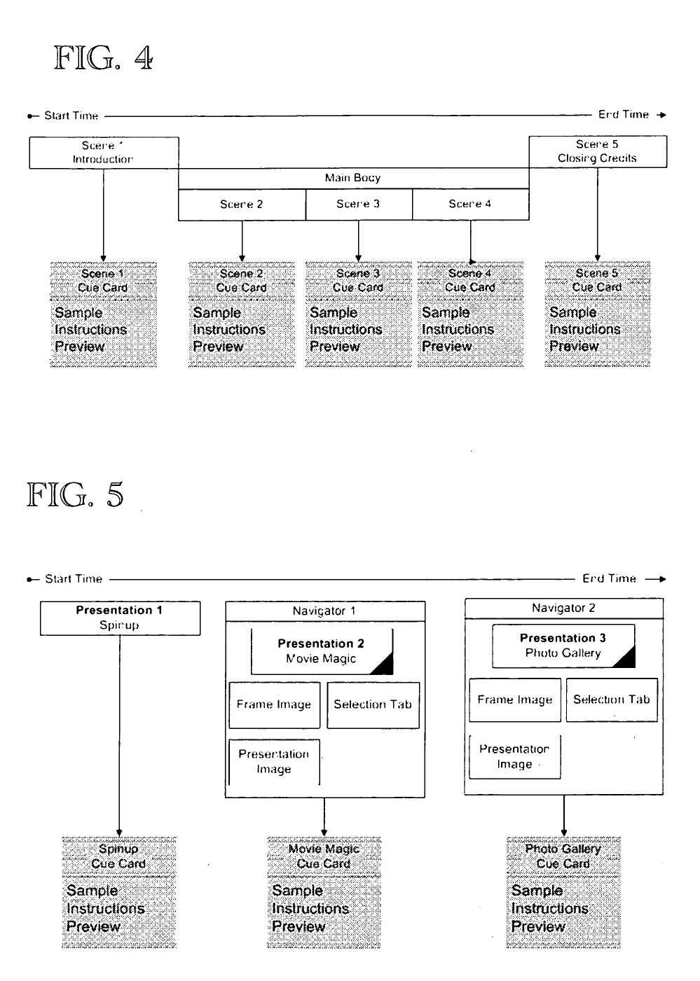

Referring now to FIG. 4, a time-oriented presentation template organization is depicted, suitable for making a video presentation to be viewed as a succession of scenes. In this example the presentation is divided into introductory, main, and closing sections. As can be seen, a section can be defined to contain several scenes, such as in the main section here. Also in this example, from each scene a cue card may be produced containing related information. The cue cards depicted here are data structures of a presentation template containing instructions, a sample scene and preview information. The instructions are provided for the amateur producer describing material appropriate for the scene, and may contain cues to instruct the amateur how to take the pictures and/or video to be included in that scene. The sample scene references a sample scene and objects for the amateur. The sample may be constructed using many methods, for example an encoded video clip or a set of references to objects and processor instructions, which construction is not limited here. Preview information may also be included to assist in providing a preview for an amateur after objects are applied to the scene. In one example, preview information contains instructions or directions to apply different or simplified effects from the template to applied objects, if the computational resources for preview are not sufficient to encode a full preview in real-time. Additionally, the instructions, sample, and preview need not be distinct and may be combined if desired into a shared object. Any of the instructions, sample or preview may be omitted if they are not needed to process a template to create a multimedia presentation, if it is deemed that they are not needed to assist the amateur producer, or in the use of a partial or incomplete cued template.

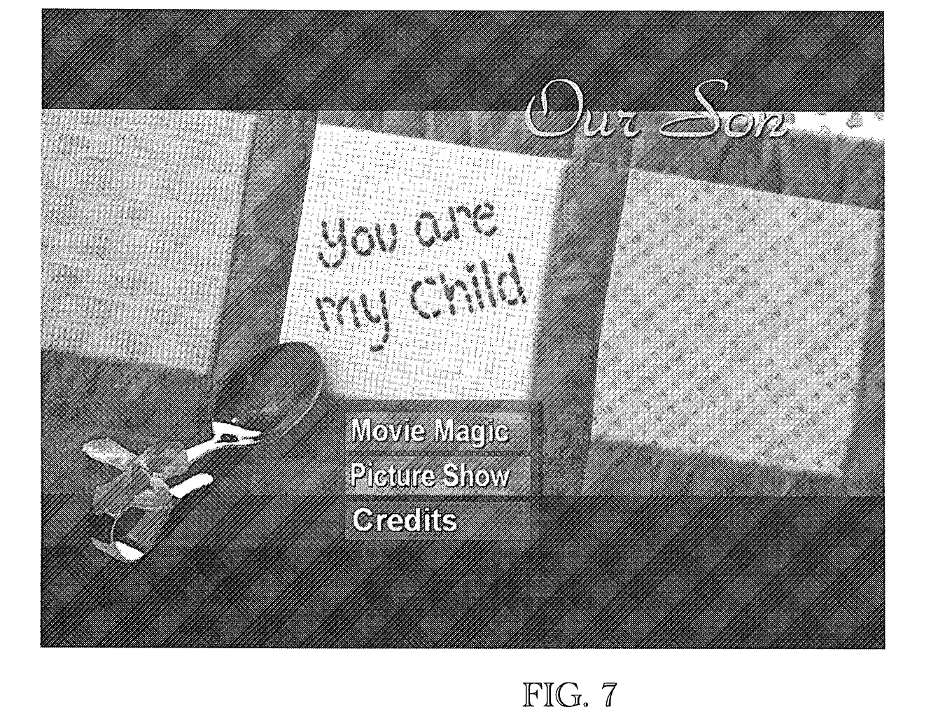

As suggested above, a presentation template including scene definitions as in FIG. 4 may be used to create a video production. Depicted in FIG. 5 is a higher level production template of such a production, including three parts including a spinup, Movie Magic and photo gallery presentation, an exemplary menu screen of which is depicted in FIG. 7. The spinup presentation is placed on the media for playback on insertion, for example as the introductory video prior to menu display on a DVD encoded media. The photo gallery in this example is a series of images organized in a simple sequential format. The Movie Magic presentation is a more sophisticated presentation of images and/or video clips created through the use of a presentation template and template elements, as described above and exemplified below. For the remainder of this discussion, the name Movie Magic will refer to an exemplary process and product created by or using presentation templates as described below.

For each of the spinup, Movie Magic and photo gallery presentations, a cue card structure may be created. These cue structures may be fashioned as described above, and may also be modified to be compatible with any associated presentation. For example, the instructions accompanying the spinup cue card might suggest to the amateur to take some generic video or an image depicting an overview, place or title of an event, or to create a video from a number of segments. The photo gallery cue card might suggest suitable formats or orders for the photo gallery. For example, if the final product is to be DVD encoded, the amateur might be cued to capture images that are 720×480 pixels, or images that have appropriate sizes or aspect ratios. The Movie Magic cue card might suggest an overall theme to that presentation, and might also include cue cards for scenes included in the Movie Magic presentation.

Exemplary Presentation Template and Cue Cards

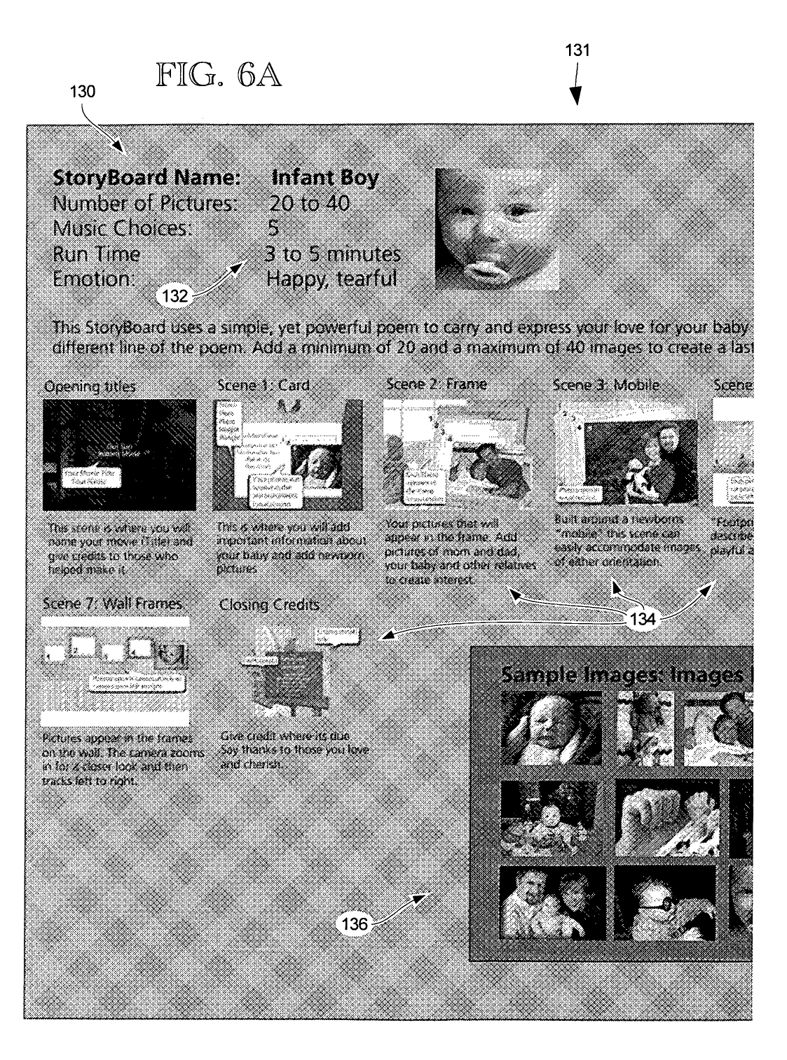

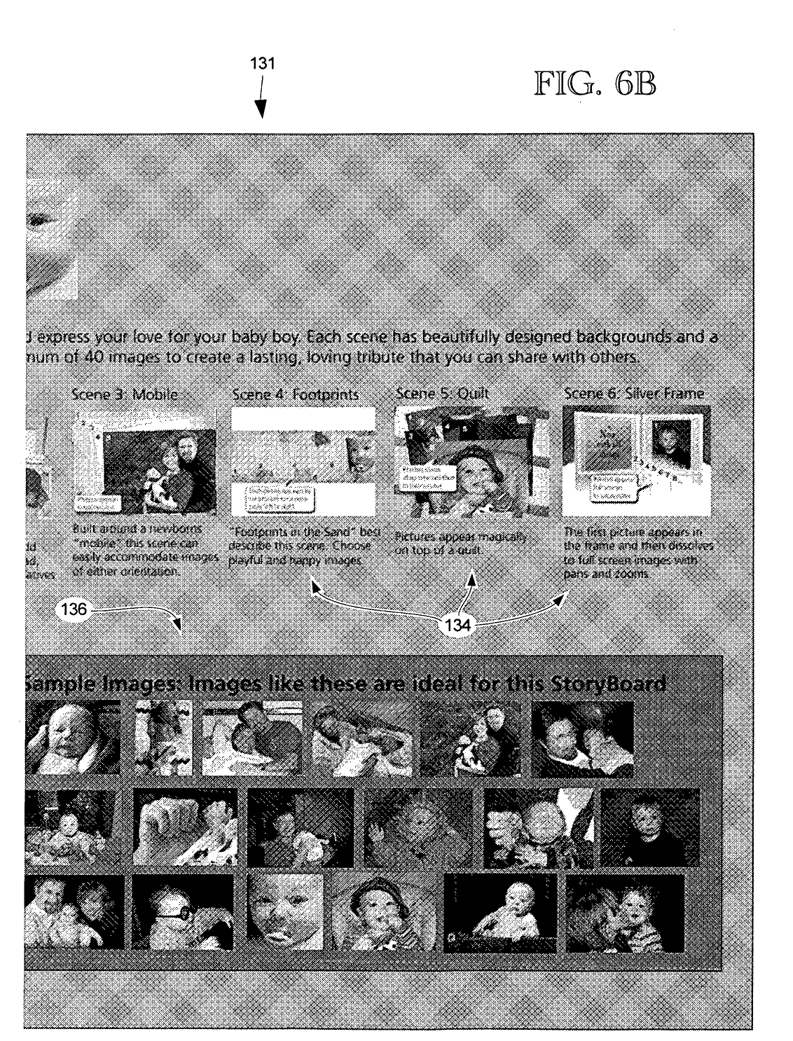

Depicted in FIGS. 6A and 6B (FIG. 6A on the left and FIG. 6B on the right in composite), hereinafter FIG. 6, is a presentation of a Movie Magic cue card 131, displaying instructions for composing a presentation and sample images 136 which offer pictures that accord to the theme of the presentation. This representation might be shown on a computer monitor in the course of reviewing the cue card and/or presentation, or might appear on a printed card for review without an electronic device. Included in the representation is a storyboard name, in this instance “Infant Boy.” A thematic description of the Movie Magic presentation template 132 provides a brief overview of the template, which is useful for selection and indexing this template in a group of others. A number of scenes 134 of the template are displayed, in this example in a pictoral and textual representation. The depiction of scenes 134 provides an overview of the included scenes and behavioral aspects in the final presentation. The scenes provided in this example demonstrate some possible behaviors, which will now be described in some detail.

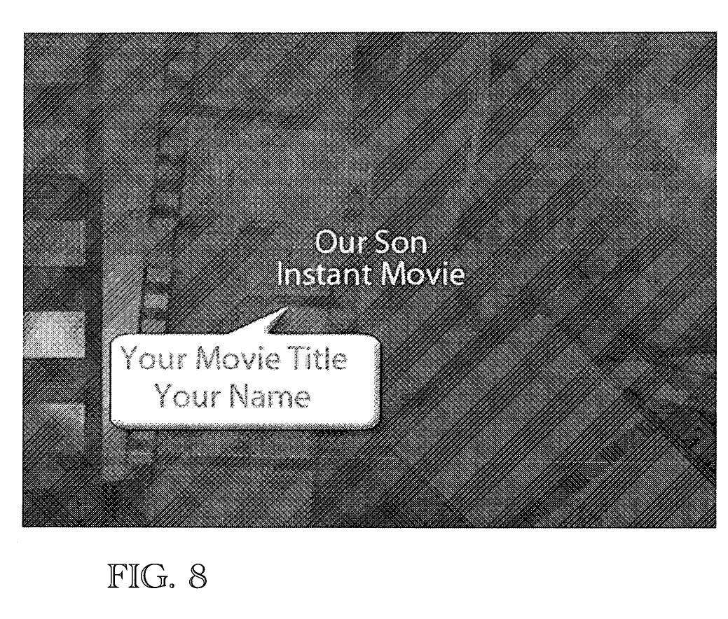

A first scene labeled “Opening Titles”, a cue card of which is shown in FIG. 8, provides a first view of the presentation. The cue card shows the default text “Our Son” and “Instant Movie”, showing a representation of the placement of information, such as text, pictures and video clips in the scene. When applied to the template, other text may be substituted by the amateur producer, for example providing the name of a child and a date. As will be seen from the discussion below, cue cards may also include information that aids the amateur in understanding the context and use of his inserted objects, as well as providing a view of the position of objects included in this scene relative to the presentation in general. The following is an XML representation of an opening cue card:
<QCard
   label=“My Movie Titles”
   instructions=“Add Titles to Your Movie”
   image=“&smginfant;\Requirements\Infant-Boy\OpeningCreditsjpg”
   presentation=“&smgmedia;\Scenes\Spinup .xml”
/>

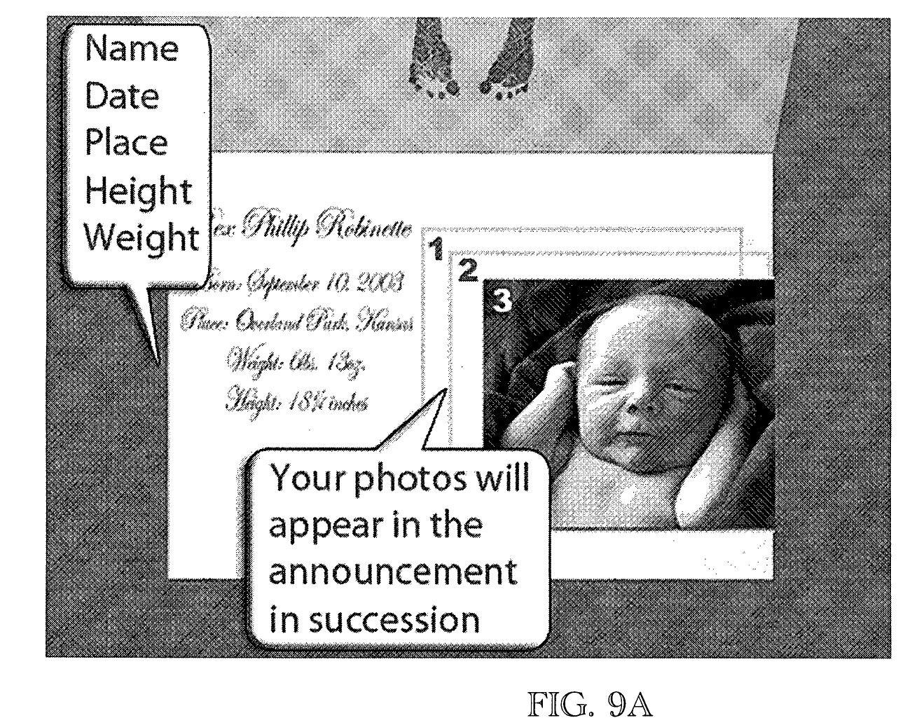

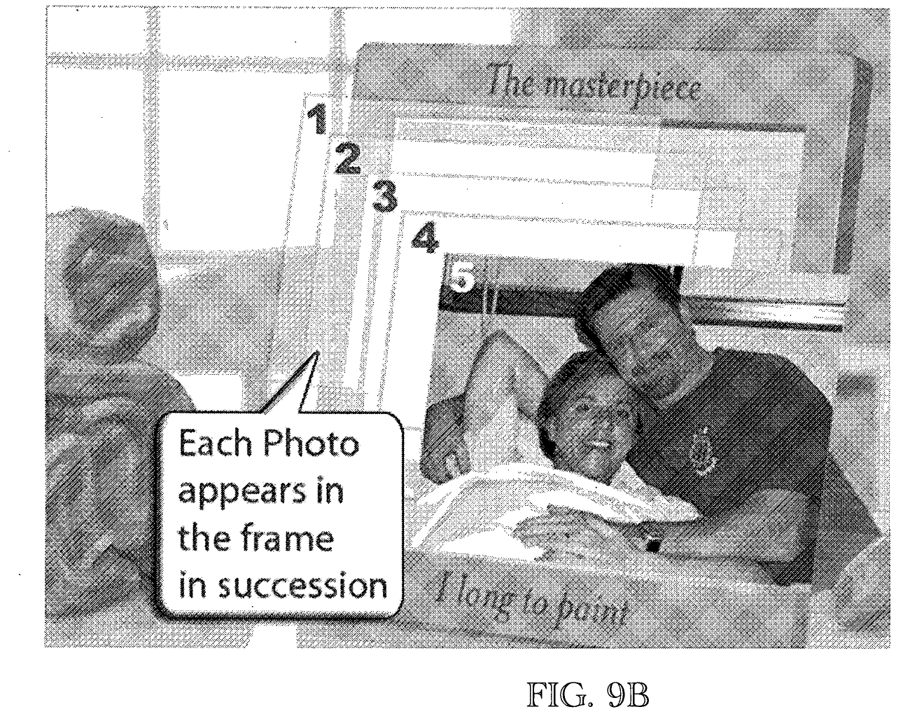

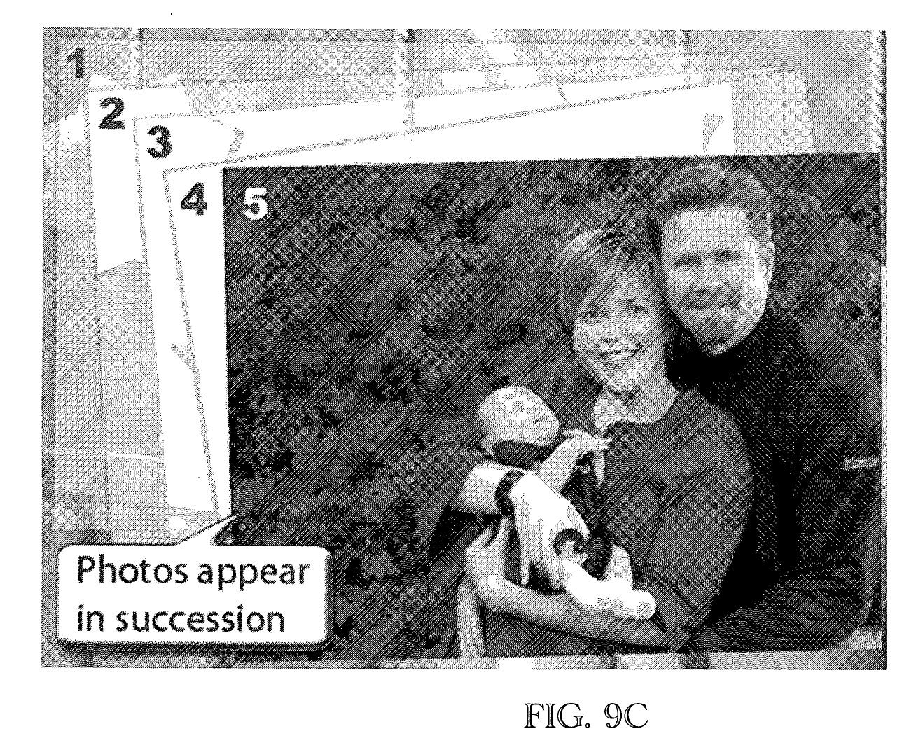

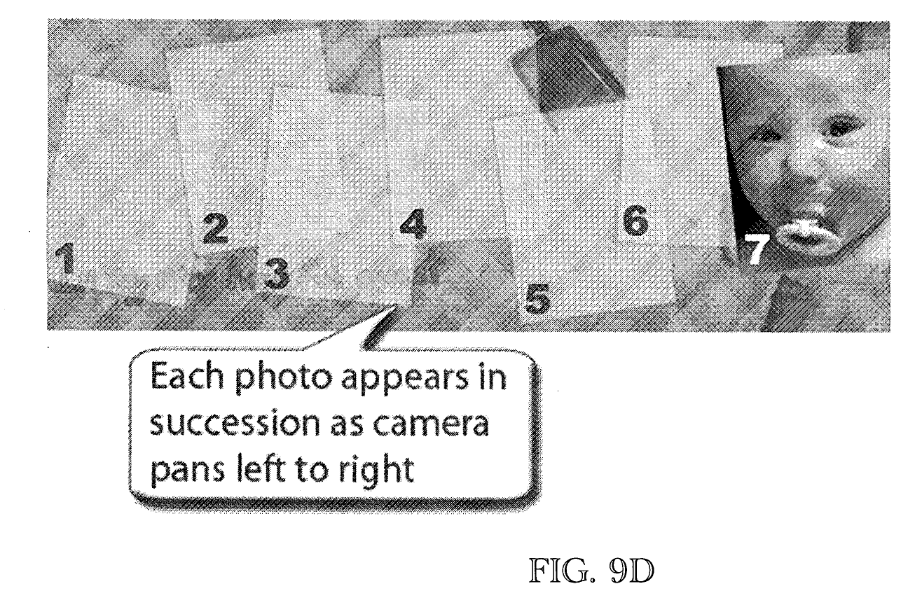

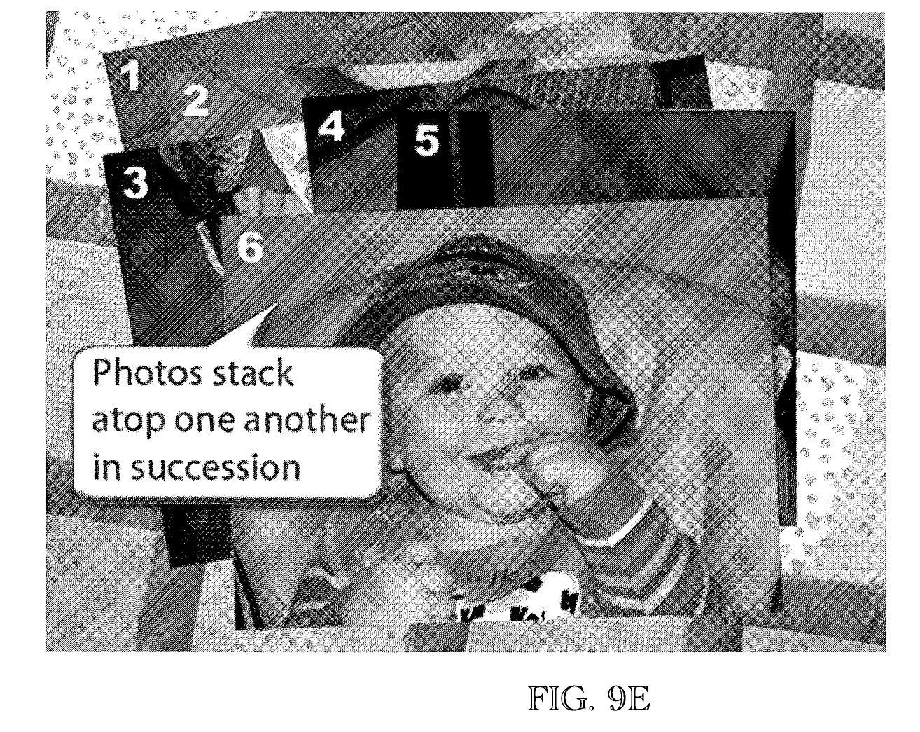

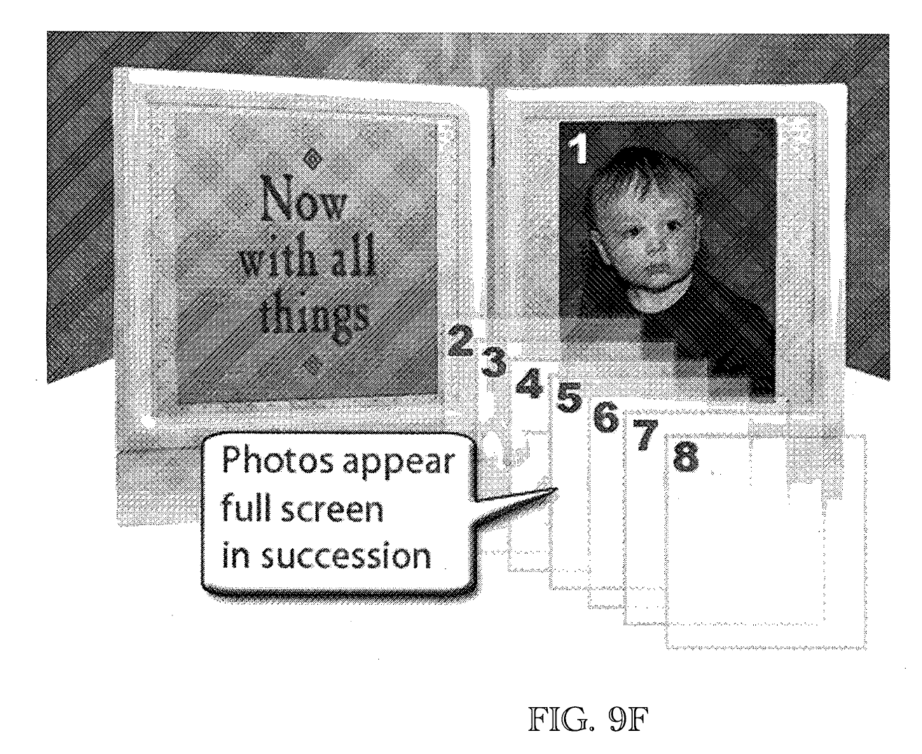

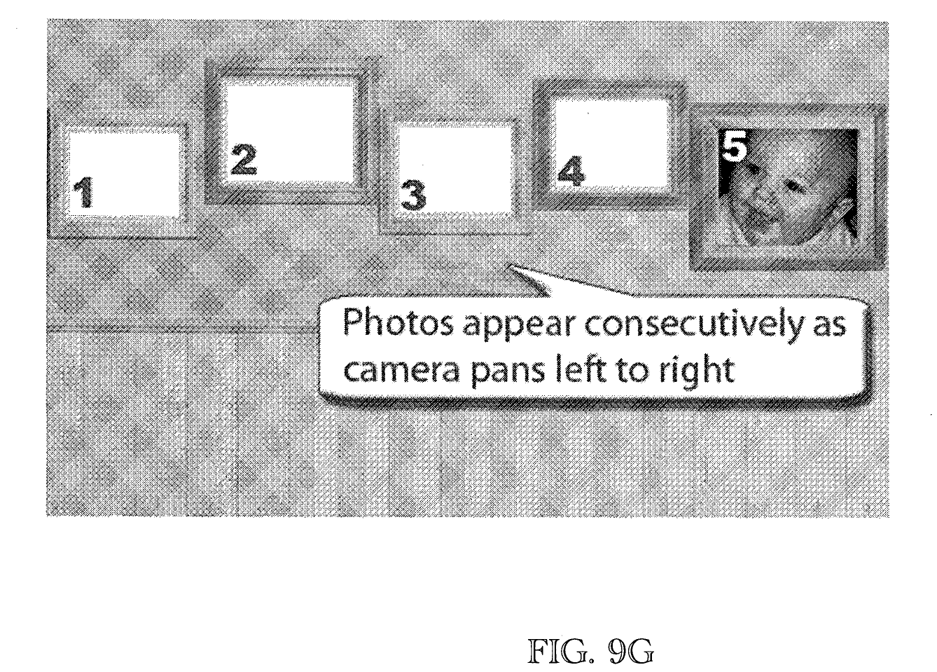

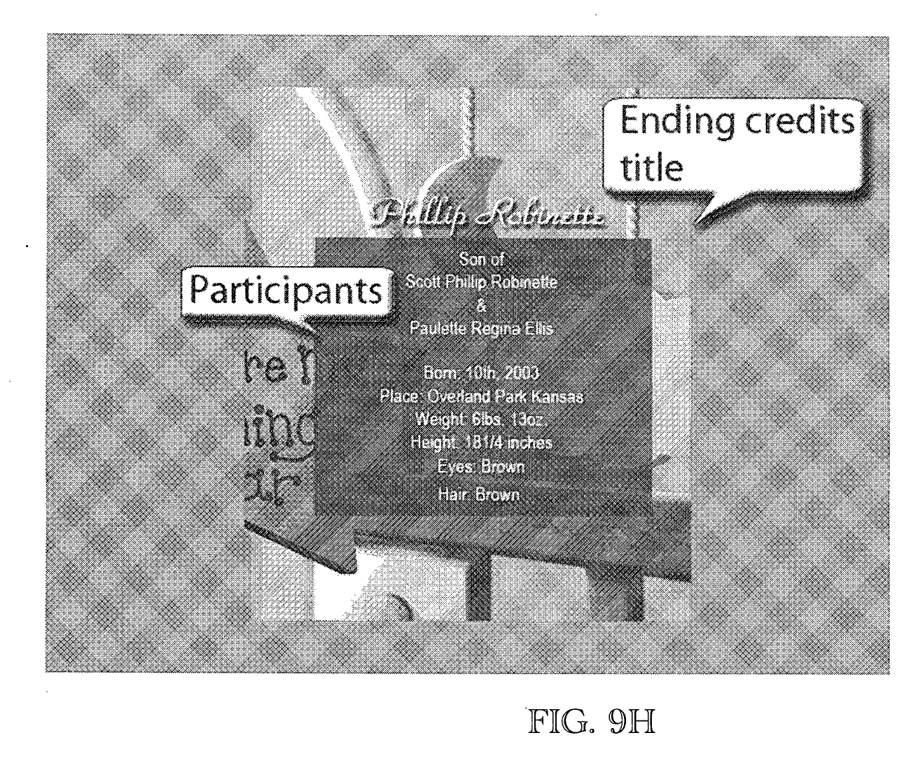

A second scene, a cue card of which is shown in FIG. 9A, entitled “card” is themed to appear as a birth announcement card, and includes several behavioral elements. The scene includes a background including a border and light background center. Several lines of text appears toward the left side of the center providing the birth date, place, weight and height of a baby, customizable by the amateur. Images of this scene are configured to appear in the positions marked 1, 2 and 3, with successive images overlaying prior ones. This cue card is captioned to indicate this image succession, offering the amateur a sufficient understanding of what behavior will occur with presentation of this scene. Successive scenes, cue cards of which are shown in FIGS. 9B, 9C, 9D, 9E, 9F and 9G and are entitled “Frame”, “Mobile”, “Footprints”, “Quilt”, “Silver Frame” and “Wall Frames” each include positions for a number of successive images.

In those cue cards captions are placed to communicate the scene theme and/or behavior to the amateur. Likewise, each of those scenes includes borders and other behavior elements, such as specified positions, rotations and sizes for the appearance of images within the template. FIG. 9B shows a cue card for a scene that includes a series of images shown in succession and rotated. The scene of FIGS. 9C and 9E also include a succession of images, but in large format and arranged to appear as a stack of photographs. The images of the scene of FIG. 9D move across the display in succession, as shown. The scenes of the cue cards of FIGS. 9F and 9G position the inserted images into a picture frame in succession. The last scene, a cue card of which appears in FIG. 9H, is entitled “Closing Credits” and offers a place for any final credits or textual messages of the presentation. The reader will note that of the scenes represented in FIGS. 9A through 9H, each has a distinct visual theme and image arrangement, adding cohesion to groups of pictures and making a more interesting presentation.

Exemplary System

In one particular exemplary system, media cue cards are used in conjunction with an Automated Multimedia Object Models (AMOM) architecture as described in U.S. patent application Ser. No. 11/051,616, incorporated by reference above. In that system, media cue cards are encoded in the object model structure, such that several objects are placed in presentation templates.

The first of these objects is a label containing a short human-readable tag to be associated with the Cue Card. The second object contains instructions in text or html encoding that communicate information to the amateur information associated with the scene to which the Cue Card applies. The third object is a sample containing a multimedia video and/or audio file showing a sample scene, presentation or production with system supplied content media. The final defined object is a raw preview, which is an AMOM-specified file to which an amateur's media may be applied. The preview is used to show how the media will look in a scene, presentation or production when complete.

In the exemplary system, cue card definitions for ordinary scenes range from simple to complex and may vary in number depending on the size of a presentation. As discussed above, presentations may be broken into two or more scenes, and each scene may have an associated cue card. In that case, each cue card may contain specifications and hints to the amateur in relation to the theme and behavior of a related scene. A cue card may also be made to contain sample images, photographs or video to give the amateur an indication of how their media should be placed in the presentation. Thus a completed cue card may contain an image as well as textual information to identify and help the amateur in the process of constructing a full presentation. The following exemplary scene cue card definition might be used in connection with the presentation shown in FIG. 6:
<QCard
   label=“Add Photos to Your Movie”
   instructions=“Add photos instantly to your movie by clicking ‘Add Checked’ to add the pre-checked photos. You can also add photos to your movie by dragging photos from the ‘My Photos’ area to the ‘Add Photo’ boxes. When you have finished adding photos to your movie, click ‘Continue’.”
   image=“&smginfant;\Requirements\Infant-Boy\Scene1.jpg”
   presentation=“&smginfant;\Infant-Boy.xml”
   sceneRefld=“CARD”

/>

Because the exemplary system is functional to create productions in DVD format, presentation and production level cue cards include DVD related information, such as the DVD label, copyright notice, author's name. Cue cards at that level may not require preview information, particularly if the corresponding scenes are static in nature and do not include user-specific information. For example, a specification for a production-level cue card for the presentation shown in FIG. 6 might appear as follows:
<QCard
   image=“&smginfant;\Requirements\Infant-Boyjpg”
   sample=“&smginfant;\Requirements\Infant-Boy.mpg”
/>

That example includes only an image and a video clip, but no preview specification. Such a cue card might appear as shown in FIG. 5.

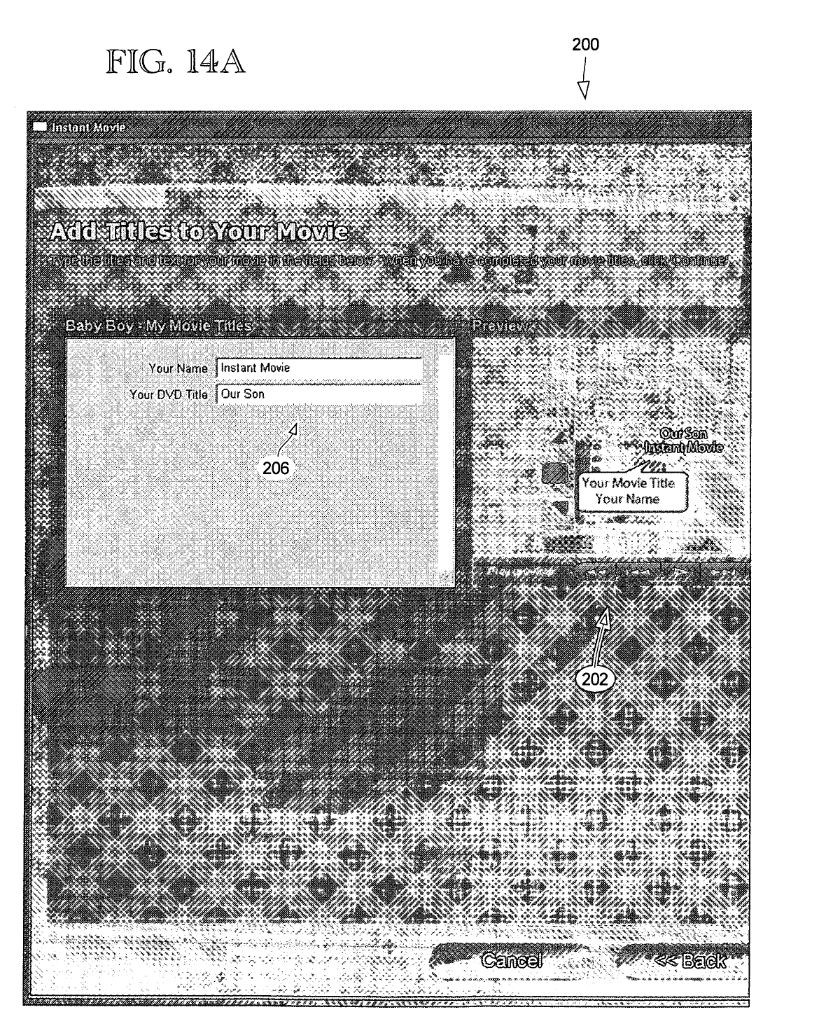

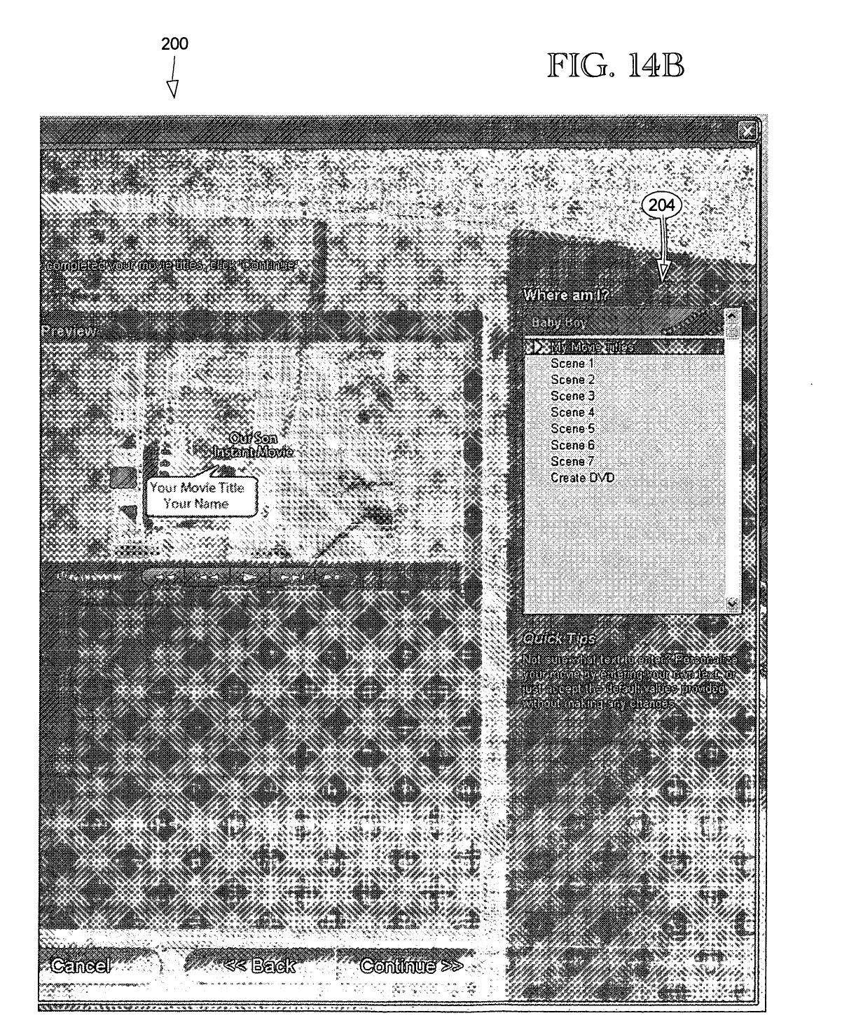

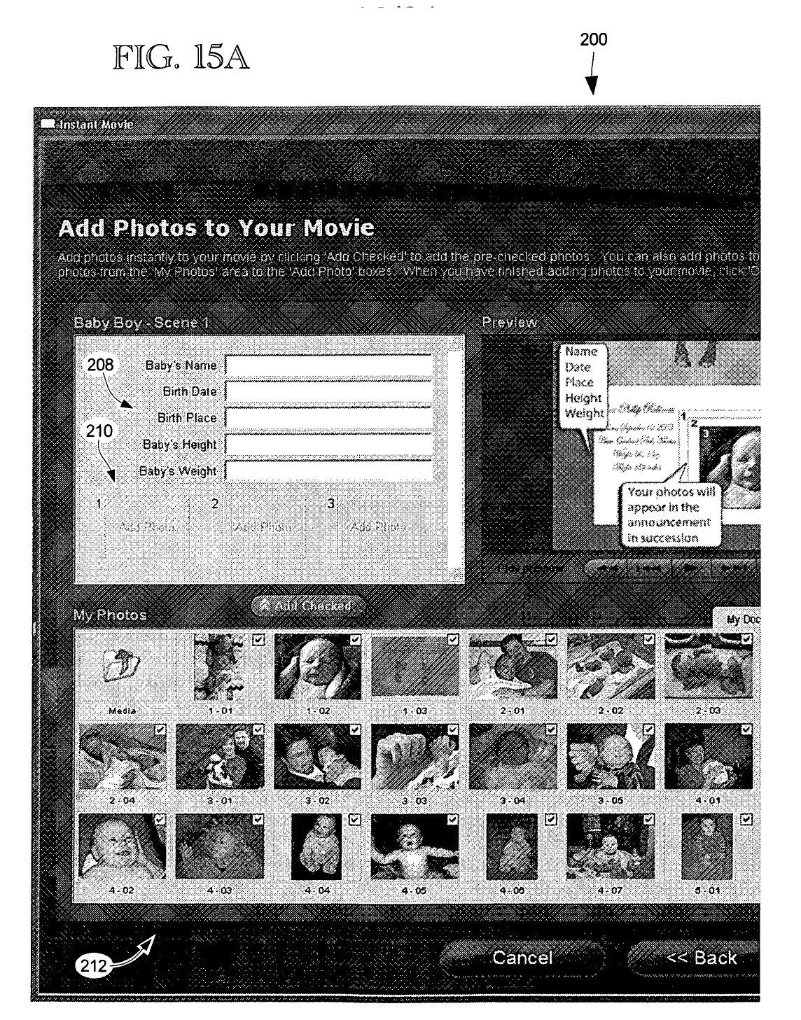

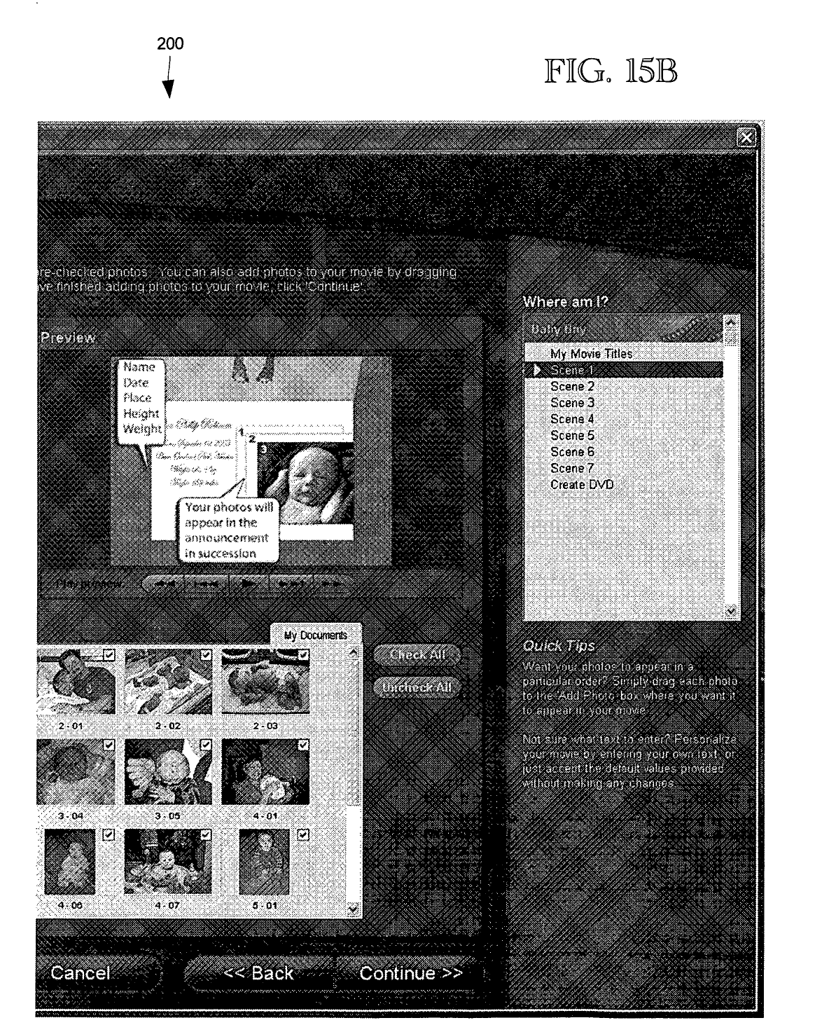

Above is discussed the insertion of multimedia objects into slots within scene templates. In the exemplary system this may be accomplished utilizing a user interface, examples of which appear in FIGS. 14A and 14B (hereinafter FIG. 14) and FIGS. 15A and 15B (hereinafter FIG. 15.) In the exemplary system media cue cards are loaded and displayed as the amateur moves to fill the contents of a scene, presentation or production. Referring now to FIG. 14, the exemplary user interface includes a window 200 that displays scenes and slots within those scenes. In FIG. 14, the scene entitled “My Movie Titles” is selected in the scene navigation pane 204, which scene corresponds to the cue card of FIG. 8. A preview 202 is provided, in this example displaying the cue card corresponding to the selected scene. Also in this interface, buttons are provided for playback of the presentation using multimedia objects populated into the scene. As the scene template for the scene of FIG. 8 includes textual slots for “Your Name” and “Your DVD Title”, text entry boxes 206 are provided to populate those entries.

Referring now to FIG. 15, the scene selection is now on scene 1, as highlighted in the scene navigation pane 204. Recalling FIG. 9A, scene 1 includes both slots for textual entry and slots for the insertion of images. For population of the textual slots of this scene, text entry boxes 208 are provided. To enter text into boxes 208, the user may select and type in the usual fashion. For population of the image slots, several “add photo” boxes 210 are displayed (more boxes may be provided through the use of the scroll function of the window shown.) In this example, to populate an image the user drags the desired image from the navigation pane 212 onto one of boxes 210. Other aspects of the exemplary user interface may be determined by inspection of FIGS. 14 and 15.

Media Cue Card Forms and Displays

As suggested above, media cue cards may be fashioned in a number of forms. One form has been described and shown above, which utilizes an XML encoding referencing images, displayed in a user interface. Likewise, media cue cards can be formed as simple text or images displayable by a computer or other display system.

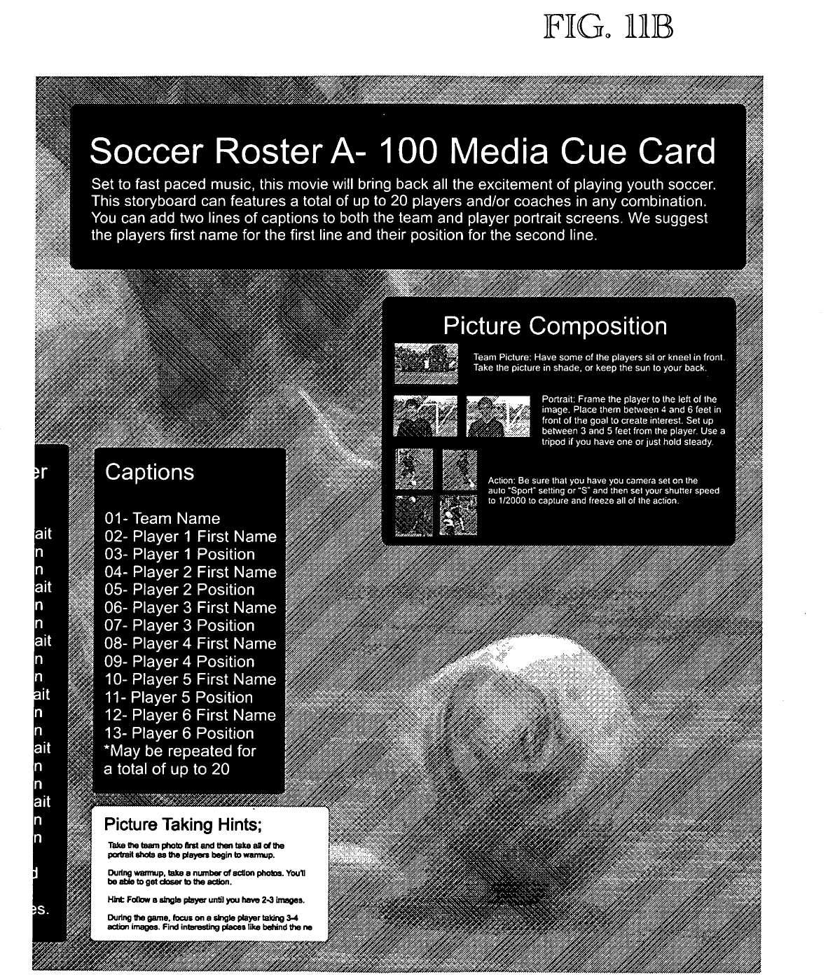

Cue cards can also be formed in physical materials for review without an electronic device. Shown in composite FIGS. 11A and 11B (hereinafter FIG. 11) is a cue card for a soccer team presentation template. This cue card provides instructions (“Picture Taking Hints” and “Picture Composition”) for the capturing of images for the template, and a description of the sequence of pictures, and thereby scenes, in the presentation. This or another cue card might be printed on heavy paper under clear lamination, and might be made in any convenient size. Alternatively, a cue card might be printed on plastic film or any other printable material.

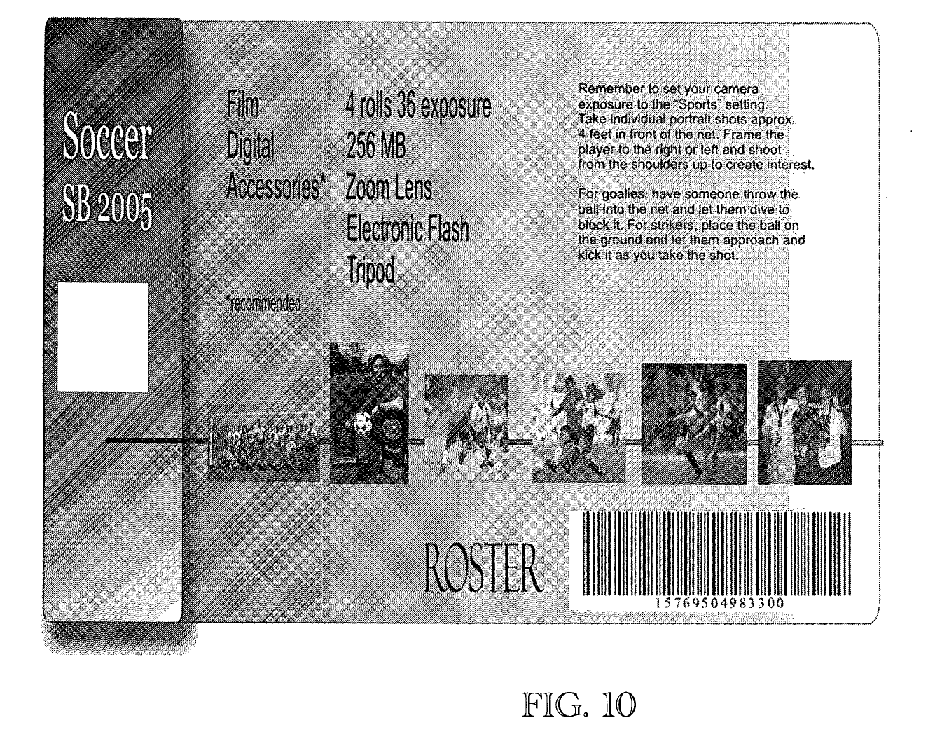

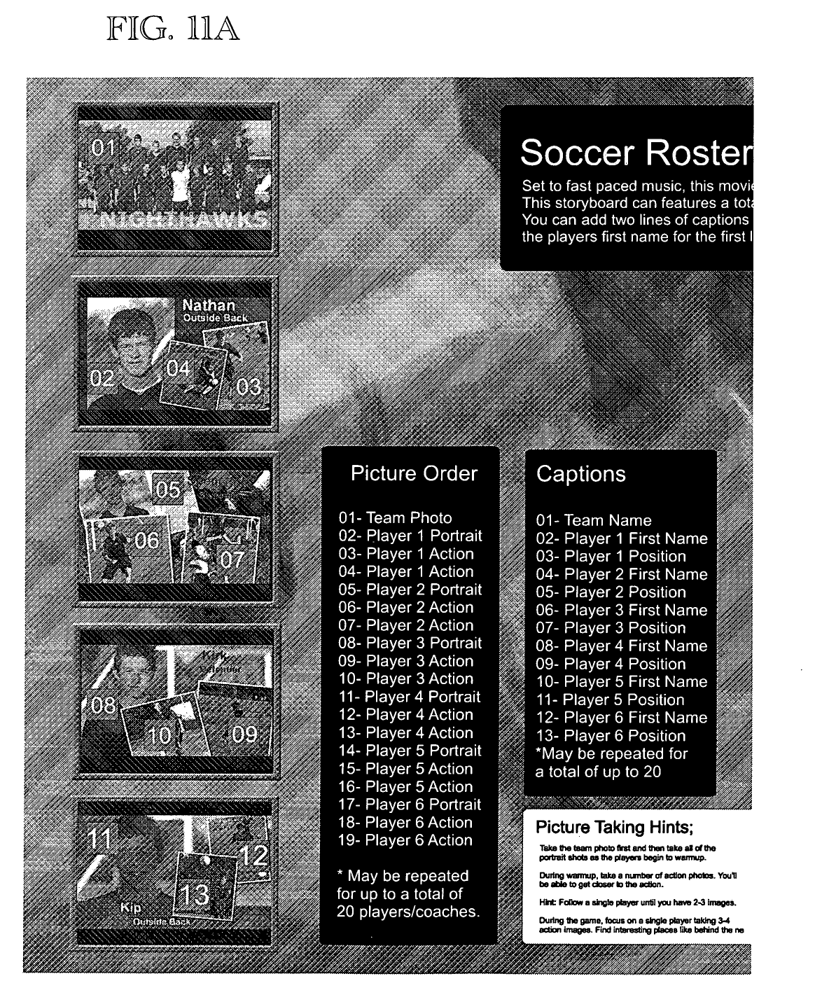

A presentation summary may also be fashioned to accompany the cue card or a set of cue cards. Continuing with the soccer team presentation, the summary of FIG. 10 may appear with the cue card of FIG. 11, for example on the reverse side of that card or as a label affixed to a package containing that cue card. As shown in FIG. 10, a summary may include a title for the applicable presentation template. Sample pictures may also be included to offer a visual indication of the theme of the intended presentation. A bar code, SKU number or other merchant identifier may also be included facilitating efficient purchasing and/or inventorying. If desired, instructions to the amateur may appear in the summary. A summary is a convenient location to list recommended equipment or accessories to be used with the presentation template. Likewise, other instructions may be included, in this example general tips for capturing interesting pictures of members of the team.

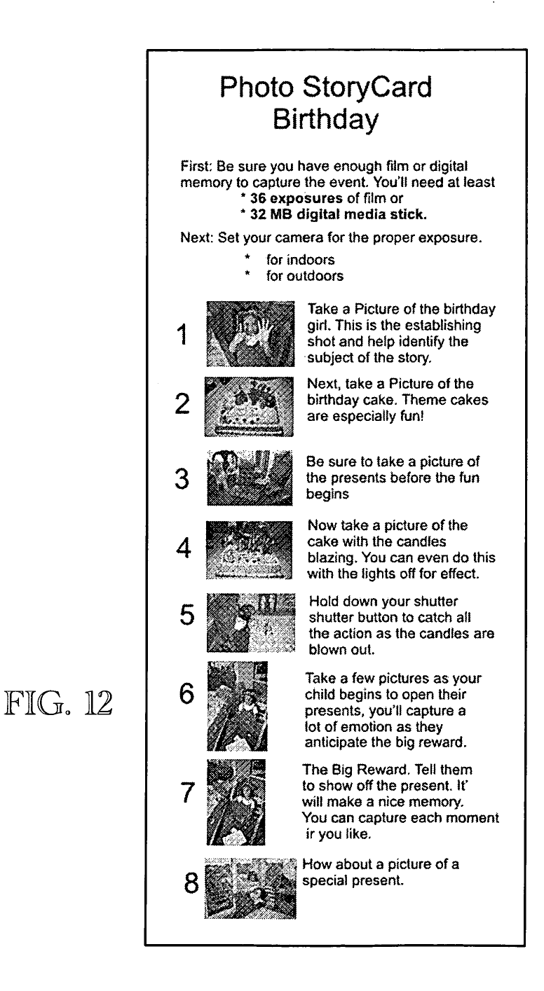

Shown in FIG. 12 is another exemplary cue card for a child's birthday party presentation. In this example the scenes are listed from top to bottom, with a suggestion of shots to take for each scene. On this card a reminder appears on the card for recommended resources, and general tips or instructions. An identification of the presentation by subject appears near the top, providing indexability when stored vertically with other cue cards in a drawer or other container.

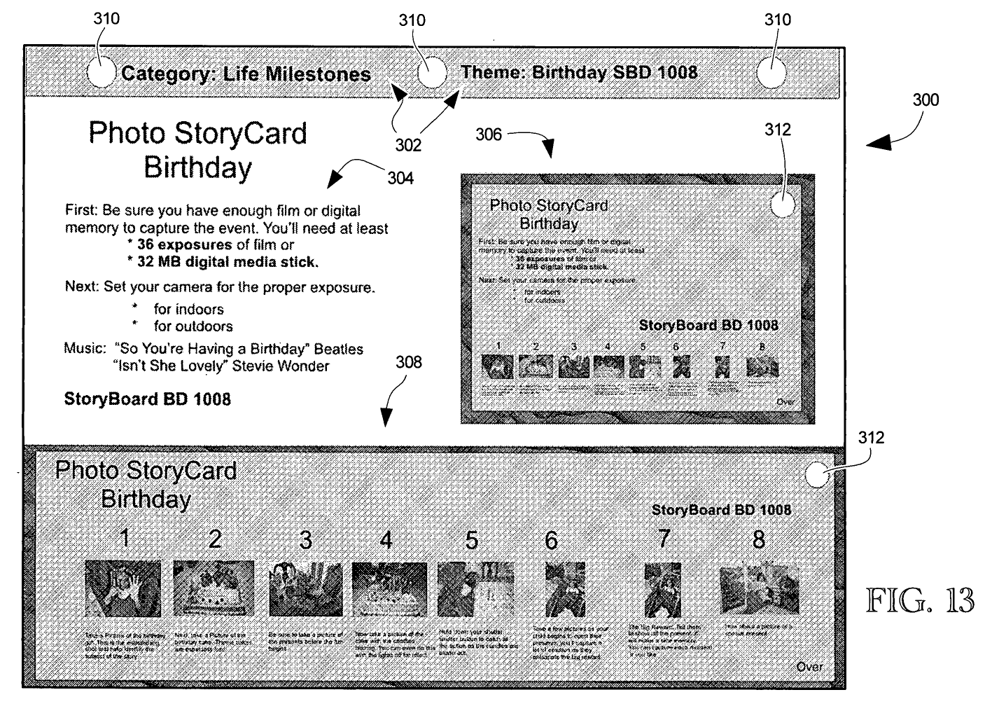

FIG. 13 depicts another exemplary cue card assembly 300 for the birthday party presentation. This format is prepared to be inserted to a three-ring binder for display and/or storage by way of punched holes 310. An index entry 302, in this example including a category, theme and identifier, is printed near the edge for convenient view while flipping through a stack of cards. A wallet-sized cue card 306 is included containing the instructions and material as shown for FIG. 10. The assembly further includes a camera-bag sized cue card 308, in the event the amateur prefers a larger size. Both of cards 306 and 308 include a punched hole 312 for stringing onto a small chain or other attachment. Instructions and recommendations 304 also appear on this card in large type for viewing while quickly thumbing through a collection of cards.

In the example of FIG. 13, cards 306 and 308 may be included using a number of methods. In a first method, assembly 300 is enclosed in a clear plastic cover, with pockets formed therein for holding cards 306 and 308. Alternatively, cards 306 and 308 may be printed with assembly cover 300, separable by the user through perforations or by cutting. To the consumer, cue cards may be displayed as they are, or may be packaged in a sleeve or other protective cover. Cue cards may also be mounted or set in a rotating or indexable display, providing convenient viewing and access by a consumer or owner.

Cards may additionally include vendor or sponsor logos, trademarks, coupons or other identification or offers. Also in the physical cue card examples above, instructions for several or all of the scenes of a presentation are included. For more complex presentations, a set of cue cards might be fashioned with one card per scene. Other arrangements may be also be used. Additionally, cue cards may be made in any convenient size, and may include folds or other features for compactness. Cards may also include information in other forms, such as encoded in magnetic strips or digital patterns.

Consumers may choose to collect specific cards and store them in specially designed plastic sleeves that are inserted in a binder. Each page and card can be removed for easy reference or attached as individually or as a whole to an image capture device or placed prominently around a consumer's house (like on a refrigerator). Cards can be easily added or eliminated and organization of cards can be determined by the consumer. For example, a consumer choosing to order the binder by calendar month could place the appropriate card behind the specific tab where it is easily referenced. For example, the card describing “Christmas” could be placed behind the “December Tab” for easy recall. Likewise, if a consumer celebrated a birthday on June 15th, the card could be filed behind the “June” tab. Other order preferences such as chronological or alphabetical could be chosen.

Now although the cue card examples above may be fashioned in a card or planar structure, there is no requirement that a cue card be formed so. Cue cards might be printed on a three-dimensional structure, such as a cube, and might even be made to fold or transform for storage if desired.

Cue cards may also be distributed in digital or computer-readable format. Electronic cue cards may be encoded in text, HTML, PDF, as images, or using any encoding permitting decoding at the point of use. In a first example, cue cards are distributed as a set of images. Those images may be displayed and printed from a computer, or may be stored on a digital camera and viewed through the camera's display. Referring now to FIG. 2, a portable media 140 containing non-volatile memory is insertable and accessible by a digital camera. Deposited to the media 140 are cue cards 142 in a format compatible with the digital camera. To view the cue cards the photographer uses the ‘review’ or similar function. As images 144 are captured, they can be stored to the portable media with the cue cards. Cue cards stored to a portable media device might be pre-programmed before sale, permitting the consumer to simply insert the programmed card into a camera and take pictures any time after purchase.

A more sophisticated digital camera might also include an interpreter for the cue card encoding. In one example, the cue cards are encoded in HTML and the digital camera includes a simple browser functional to display the locally stored cards. For cue cards destined for a digital camera, those cue cards might be deposited a portable memory apart from a memory for storing captured images. Alternatively, that cue card memory might be internal to the camera.

Accompanying the cue cards, either on a separate or an internal memory, might be stored the corresponding template. At the time of presentation production, the images and templates would then be conveniently located together. An advanced camera might include functionality to read a template or cue card, and set or assist with camera functions such as shutter speed, image format and other effects.

In another example, cue cards might be stored to a portable electronic device, such as a PDA or portable video player. Many PDAs include an HTML browser, making the PDA a convenient container and viewer for compatible cue cards.

Distribution

Media cue cards may be distributed in a variety of ways. One method utilizes point of purchase displays carried in retail, wholesale or other physical outlets sitting on countertops or standalone. Cards may be stored and organized into binders by category and theme for easy reference. Alternatively, cue cards may be packaged with cameras, film, picture frames, digital storage devices, film prints, photo paper, computers, printers, scanners, software or any other image capture or display related product.

Cue cards might also be distributed as software on a standalone basis, packaged with other software or carried on hardware. Cue Cards could also be distributed through a public network such as the Internet or on the Web as a download. Likewise, distribution could be made to cellular telephones, PDAs or other portable electronic devices through a wireless link. Independent distributors and network marketing companies might also supply cue cards.

Distribution might also be made through a kiosk or other automated point of purchase where the media cue cards are stored in the memory of the kiosk CPU and individual cards are accessed by navigating categories and themes. The cue cards could be programmed by insertion of the consumer's portable media into the kiosk. The kiosk could also include functionality for building productions, thereby acting as a production processor. For example, the amateur could bring a DVD-R media insertable into the kiosk and thereby into the production processor to be burned or recorded. Alternatively, the Kiosk could house a supply of media. Print copies of cue cards could be obtained by using a photo printer or receipt printer.

In another alternative, sample cue cards may be provided to users purchasing a film camera, digital camera or video camera with a set of cards upon a purchase to help them to use their newly purchased equipment more effectively. Additional examples include bundling media cue cards with multimedia software, image management software and photo slideshow software to show users how to compose and organize their media into a form that can then be converted to a digital format using the software.

Examples of use for distribution to targeted users include packaging a specific themed card with a copy of multimedia software. For example a company that vends sportswear could, using this method, develop a package for youth sports programs by packaging the “Little League Baseball” media cue card with multimedia software containing a pre developed and coded template that incorporates pre developed “stock media” like media and messaging from one of the compensated sports spokesman with media captured by the customer. Distributed directly to the coach or sports camp, the coach could distribute the cards to the player's parent who could capture media as outlined in the card the personalize the media/message by inserting the captured media into the multi-media software producing a DVD, CD or other media output. Cue cards and production processing equipment could also be located at tourist sites, such as theme parks, enabling a visitor to return home with a multimedia record of his vacation.

Sales of products and services associated with the creation of a multimedia story can be tied to the cards. Vendors selling products like film, digital media, cameras, scanners could benefit from the association with a media cue card by printing an advertisement or promotion on the card. Service providers could also benefit from use of the cards by users of the card who will need to purchase services like film development to complete a story.

Media cue cards can be arranged and provided by general category, category themes, and theme sub-themes to provide specific story telling elements for life events and other occasions. Shown in Table 1 is a sample of an exemplary organization of presentations that would be of interest to amateur producers.

TABLE 1

| Category | Sub-categories & Themes |
|---|---|
| All Occasion | Introductions, Galleries, Slideshows, Credits |
| Holidays & Celebrations | Christmas, Thanksgiving, Mother's Day, |
| | Father's Day, Easter, Halloween, New Year's |
| | Day, Fourth of July, Family Reunion School |
| | Dance, Spring Break, Valentine's Day |
| Life Milestones | Anniversary, Birth, Birthday, Back to School, |
| | Engagement, Graduation Honeymoon, |
| | Sympathy, Yearbook, Wedding |
| Sports & Recreation | Baseball, Basketball, Dance, Football, Golf, |
| | Skateboarding, Skiing, Snowmobile, Soccer, |
| | Swimming, Tennis |
| Travel & Fun | Camping, Cruises, Honeymoon, Road Trip, |
| | Theme Park Summer Vacation, Winter |
| | Vacation |
| Family & Friends | Brother, Children, Family Reunion, Father, |
| | Friends, Grandfather Grandmother, Mother, |
| | School Reunion, Sister |
| Hobbies & Interests | Music, Painting, Photography, Pets, Recitals |
| Thinking of You | Tribute, Love, Respect |
| Life Sketch | Birth, the Early Years, Teen Life, Entering |
| | Adulthood, Getting Married, Raising a Family, |
| | Empty Nesters, The Golden Years, Tribute, |
| | Other |

Although the above examples have focused on creating multimedia productions from still pictures and images, the techniques described above may be equally applied to video clips, audio clips and other multimedia input material. Additionally, while the examples above describe a production to DVD format, media cue cards and multimedia template systems may be applied to produce output in practically any format, even to photo albums and scrapbook pages. And while multimedia production systems, templates and media cue cards have been described and illustrated in conjunction with a number of specific configurations and methods, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

What is claimed:

1. A method of using production templates and cue cards to make a multimedia production, comprising the steps of:
creating a presentation template including a plurality of scenes, each of said scenes including at least one slot for the insertion of a multimedia object, said template further including elements that define the scenes of the template;
creating a set of media cue cards containing at least one card, wherein the set of cards contains instructions that specify to a user how to capture multimedia objects that are compatible with the scenes;
providing the media cue cards to a user;
providing a production processor to the user;
receiving specifications for multimedia objects captured by the user to fill the slots in the scenes of the production template; and
applying the elements to the specified multimedia objects.

2. A method according to claim 1, further comprising the step of providing, in connection with the created set of media cue cards, an overview or identifier for the production template.

3. A method according to claim 1, wherein said media cue cards comprise at least one physical medium.

4. A method according to claim 3, wherein said media cue cards are fashioned as cards and further include an identifier located in an index position suitable for flipping through a series of cards to identify said media cue cards.

5. A method according to claim 1, wherein said media cue cards are computer-readable.

6. A method according to claim 5, wherein said media cue cards are provided over a public network.

7. A method according to claim 5, wherein said media cue cards are provided on a portable memory device.

8. A method according to claim 7, wherein said media cue cards are readable by a camera, and wherein said method further comprises the step of reviewing the media cue cards through a display in the camera.

9. A method according to claim 1, further comprising providing sample scenes in connection with the media cue cards.

10. A method of using production templates and cue cards to make a video presentation from a set of still images, comprising the steps of:
creating a production template including a plurality of scenes, each of said scenes including at least one slot for the insertion of an image, said template further including elements that define the scenes of the template and transitions of inserted images;
creating a set of media cue cards containing at least one card, wherein the set of cards contains instructions that specify to a user how to capture images that are compatible with the scenes, wherein each media cue card includes an identifier to a scene in the production template;
providing the media cue cards to a user;
capturing multimedia objects;
providing a production processor to the user;
receiving specifications for images captured by the user to fill the slots in the scenes of the production template;
applying the elements to the specified images; and
producing a multimedia production.

11. A method according to claim 10, wherein said media cue cards comprise at least one physical medium.

12. A method according to claim 11, wherein said media cue cards are fashioned as cards and further include an identifier located in an index position suitable for flipping through a series of cards to identify said media cue cards.

13. A method according to claim 11, wherein said media cue cards are presented in a rotating or indexable display to consumers.

14. A method according to claim 10, wherein said media cue cards are computer-readable.

15. A method according to claim 14, wherein said media cue cards are provided over a public network.

16. A method according to claim 14, wherein said media cue cards are provided on a portable memory device.

17. A method according to claim 16, wherein said media cue cards are readable by a camera, and wherein said method further comprises the step of reviewing the media cue cards through a display in the camera.

18. A method of using production templates and cue cards to make a video presentation from a set of still images, comprising the steps of:
creating a presentation template including a plurality of scenes, each of said scenes including at least one slot for the insertion of an image, said template further including elements that define the scenes of the template and transitions of inserted images;
creating a set of media cue cards containing at least one card, wherein the set of cards contains instructions that specify to a user how to capture images that are compatible with the scenes, wherein each media cue card includes an identifier to a scene in the production template;
providing the media cue cards to a user with sample scenes;
capturing multimedia objects;
providing a production processor to the user;
receiving specifications for images captured by the user to fill the slots in the scenes of the production template;
applying the elements to the specified images; and
producing a multimedia production.

19. A method according to claim 17, further comprising the step of providing recommended multimedia object capture resources in connection with the media cue cards.

20. A method according to claim 17, wherein the media cue cards also include a description or depiction of how successive images will appear in scenes of the produced multimedia presentation.

21. A method according to claim 17, wherein the media cue cards include suggestions for views, distances and vantages for capturing multimedia objects in accordance with the scenes of the presentation template.
